(19) United States
(12) Patent Application Publication
(10) Pub. No.: US 2010/0013212 A1
(43) Pub. Date: Jan. 21, 2010

(54) Gardening Movable Adapter Whose Output Flow can be Controlled and Regulated

(76) Inventor: Shih-Chung Cheng, Hemei Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/175,670

(22) Filed: Jul. 18, 2008

(51) Int. Cl. F16L 55/00

(52) U.S. Cl. 285/18

(57) ABSTRACT

An adapter for a gardening tool includes an adapter body, a connecting member, and a control member. The connecting member is rotatably mounted on the adapter body. The control member is rotatably mounted on the connecting member. The control member has a mounting tube which is provided with an oblique control flange. Thus, the control flange of the control member can be moved to close or open the water flow of the adapter and to change and regulate the water output flow from the adapter by rotation of the control member, thereby facilitating a user operating the adapter to close or open the water flow and to change and regulate the water output flow.

### BACKGROUND OF THE INVENTION

1. Field of the Invention

The present invention relates to an adapter and, more particularly, to a movable adapter for a gardening tool, such as a spraying gun or sprinkler.

2. Description of the Related Art

A conventional adapter 70 in accordance with the prior art shown in FIG. 12 is used to connect a spraying gun 60 and a hose 80 and comprises a first connector 71 for connecting the spraying gun 60, and a second connector 72 for connecting the hose 80. The first connector 71 has an outer thread screwed into a threaded hole 62 of a shank 61 of the spraying gun 60. The second connector 72 has a distal end provided with an elastic locking pawl 73 for locking the hose 80, and a clamping ring 74 is rotatably mounted on the second connector 72 to press the locking pawl 73 toward the hose 80 by rotation of the clamping ring 74 so as to lock the locking pawl 73 on the hose 80. Thus, the water from the hose 80 flows through the adapter 70 into the spraying gun 60 and is injected outwardly from the spraying gun 60 for use with a user.

However, the adapter 70 is only used to connect the spraying gun 60 and the hose 80 and cannot be used to open/close the water or to control the output flow of the spraying gun 60, so that the user has to return to the water source to open/close the water or to control the output flow of the spraying gun 60, thereby causing inconvenience to the user. In addition, the angle between the hose 80 and the spraying gun 60 is fixed and cannot be changed so that the hose 80 is easily tangled with the spraying gun 60 during operation of the spraying gun 60, thereby facilitating the user operating the spraying gun 60. Further, the angle between the hose 80 and the spraying gun 60 is fixed and cannot be changed so that the hose 80 is easily rolled or revolved when the direction of the spraying gun 60 is changed, and is easily twisted, distorted or deformed.

### BRIEF SUMMARY OF THE INVENTION

The primary objective of the present invention is to provide a gardening movable adapter whose output flow can be controlled and regulated.

Another objective of the present invention is to provide an adapter for a gardening tool, wherein the control member can be rotated to move the control flange, so that the control flange of the control member can be moved to close or open the water flow of the adapter and to change and regulate the water output flow from the adapter by rotation of the control member, thereby facilitating a user operating the adapter to close or open the water flow and to change and regulate the water output flow.

A further objective of the present invention is to provide an adapter for a gardening tool, wherein the connecting member is pivotable relative to the adapter body to adjust the angle between the connecting member and the adapter body so as to adjust the angle between the hose and the spraying gun to prevent the hose from being tangled with the spraying gun, thereby facilitating the user operating the spraying gun.

A further objective of the present invention is to provide an adapter for a gardening tool, wherein the connecting member is pivotable relative to the adapter body to adjust the angle between the hose and the spraying gun, so that the hose will not be rolled or revolved when the direction of the spraying gun is changed, thereby preventing the hose from being twisted, distorted or deformed.

A further objective of the present invention is to provide an adapter for a gardening tool, wherein the connecting portion of the adapter body, the connecting section of the connecting member and the control member are combined together by the pivot bolt and the fastening nut, so that the adapter has a greater strength to withstand a water flow of high pressure.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an adapter for a gardening tool in accordance with the preferred embodiment of the present invention.

FIG. 2 is an exploded perspective view of the adapter for a gardening tool as shown in FIG. 1.

FIG. 2a is a perspective view of a connecting member of the adapter for a gardening tool as shown in FIG. 2.

FIG. 3 is a bottom perspective view of the connecting member of the adapter for a gardening tool as shown in FIG. 2.

FIG. 4 is a perspective view of a control member of the adapter for a gardening tool as shown in FIG. 2.

FIG. 5 is a front cross-sectional view of the adapter for a gardening tool as shown in FIG. 1.

FIG. 6 is a perspective view showing that the adapter is used to connect a spraying gun and a hose.

FIG. 7 is a schematic operational view of the adapter for a gardening tool as shown in FIG. 5.

FIG. 8 is a schematic operational view of the adapter for a gardening tool as shown in FIG. 6.

FIG. 9 is a schematic operational view of the adapter for a gardening tool as shown in FIG. 8.

FIG. 10 is a perspective view showing that the adapter is used to connect a spraying gun and a hose.

FIG. 11 is a perspective view showing that the adapter is used to connect two hoses.

FIG. 12 is a front cross-sectional view of a conventional adapter for a gardening tool in accordance with the prior art.

### DETAILED DESCRIPTION OF THE INVENTION

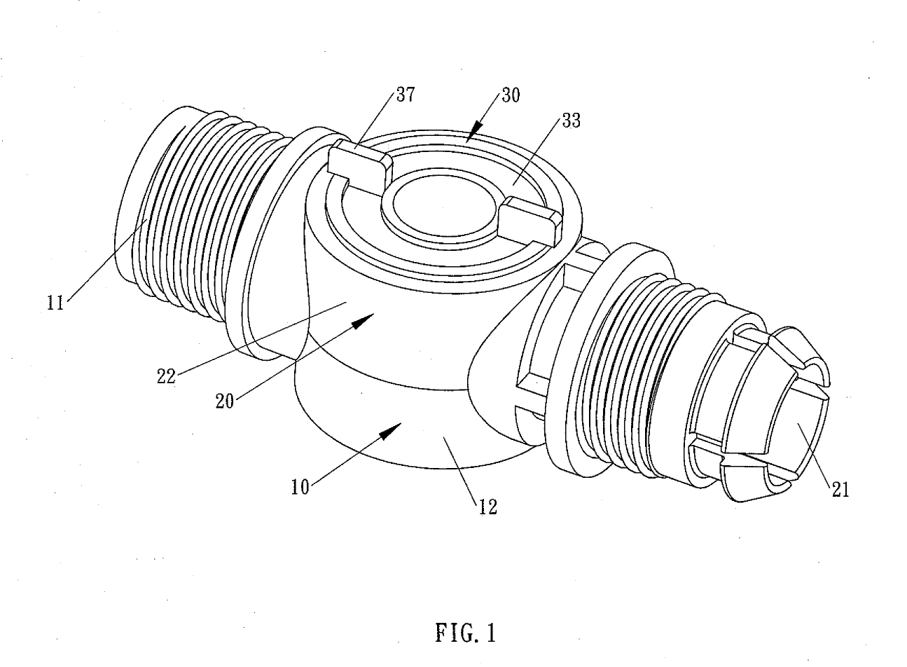

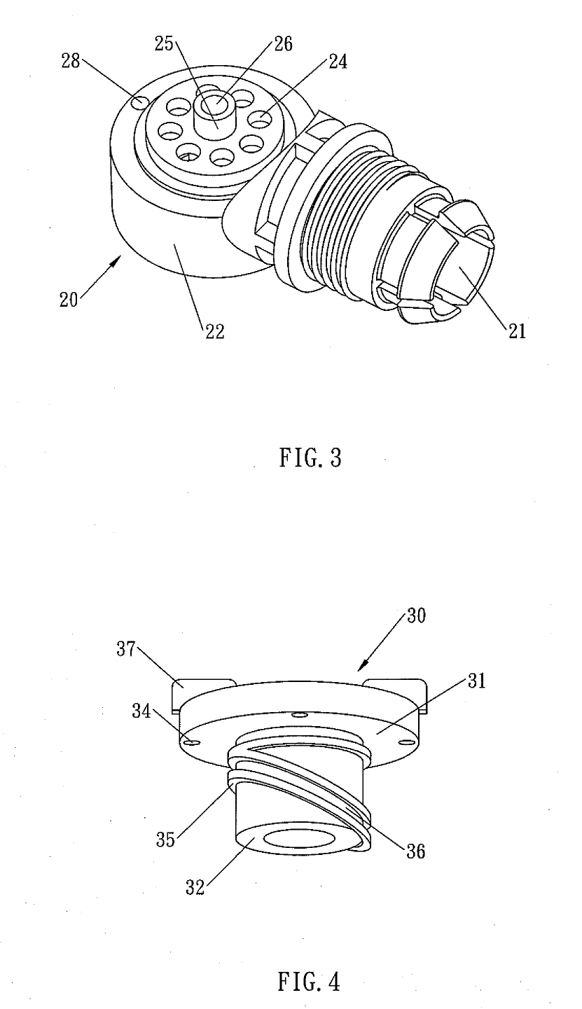

Referring to the drawings and initially to FIGS. 1-5, an adapter for a gardening tool in accordance with the preferred embodiment of the present invention comprises an adapter body 10, a connecting member 20, and a control member 30.

The adapter body 10 has a first side provided with a connecting portion 12 and a second side provided with a hollow mounting portion 11. The connecting portion 12 of the adapter body 10 has an inside provided with a recessed flow space 13. The connecting portion 12 of the adapter body 10 has a peripheral wall provided with a water outlet 15 connected between the flow space 13 and the mounting portion 11.

The connecting portion 12 of the adapter body 10 has a top provided with a plurality of positioning holes 16. The inside of the connecting portion 12 of the adapter body 10 is further provided with a mounting sleeve 14 located in the flow space 13.

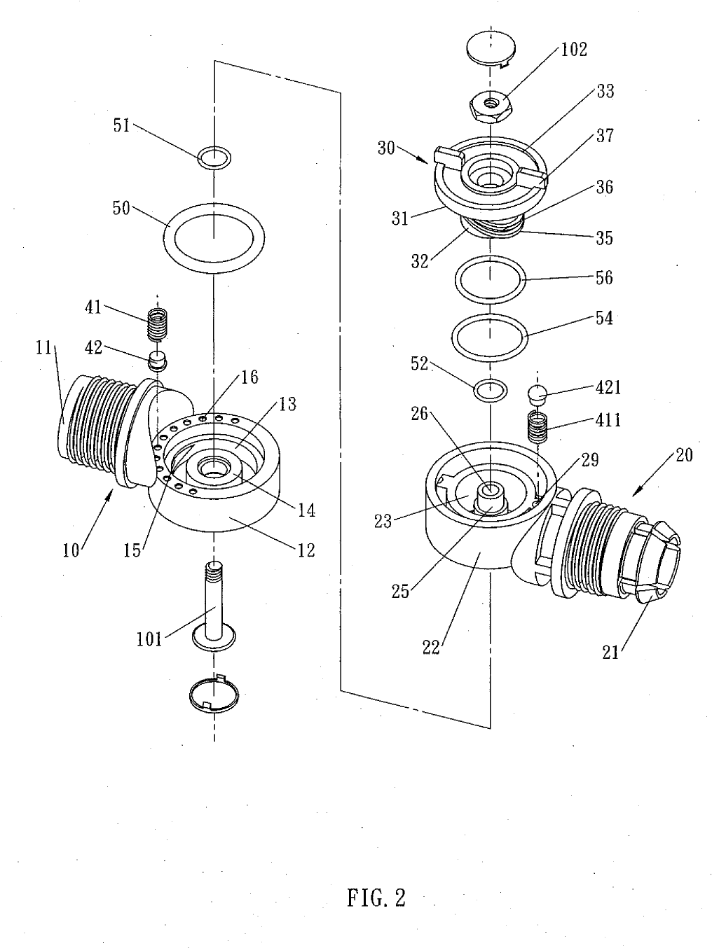

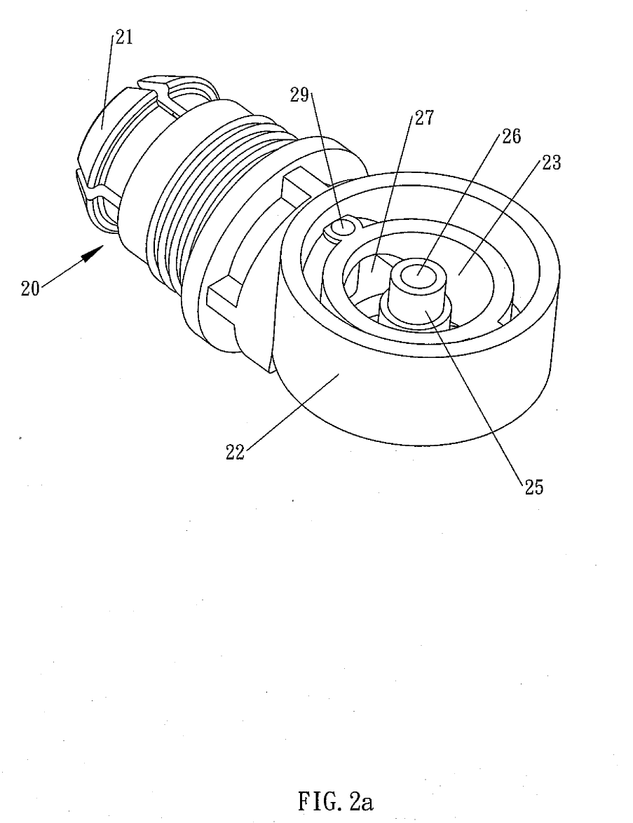

The connecting member 20 is mounted on the adapter body 10 and has a first side provided with a connecting section 22 mounted on the connecting portion 12 of the adapter body 10 and a second side provided with a hollow mounting section 21. The connecting section 22 of the connecting member 20 has an inside provided with a recessed flow chamber 23 and has a bottom provided with a plurality of connecting holes 24 (see FIG. 3) connected between the flow chamber 23 and the flow space 13 of the adapter body 10. The connecting section 22 of the connecting member 20 has a peripheral wall provided with a water inlet 27 (see FIG. 2a) connected between the flow chamber 23 and the mounting section 21.

The connecting section 22 of the connecting member 20 is located between the connecting portion 12 of the adapter body 10 and the control member 30 and is rotatably mounted on the connecting portion 12 of the adapter body 10 by a pivot bolt 101 so that the connecting member 20 is pivotable relative to the adapter body 10 to adjust an angle between the connecting member 20 and the adapter body 10. The connecting section 22 of the connecting member 20 has a top provided with a receiving bore 29. The bottom of the connecting section 22 of the connecting member 20 has a periphery provided with a receiving hole 28. The connecting section 22 of the connecting member 20 has a peripheral wall provided with a plurality of indication symbols (not shown). The inside of the connecting section 22 of the connecting member 20 is further provided with a mounting post 25 located in the flow chamber 23. The mounting post 25 of the connecting member 20 has an inside provided with a through hole 26 to allow passage of the pivot bolt 101. The mounting post 25 of the connecting member 20 has a lower end protruding outwardly from the bottom of the connecting section 22 of the connecting member 20 as shown in FIG. 3 and inserted into the mounting sleeve 14 of the adapter body 10 so that the mounting post 25 of the connecting member 20 is rotatably mounted on the mounting sleeve 14 of the adapter body 10. The mounting post 25 of the connecting member 20 has an upper end inserted into the mounting tube 32 of the control member 30.

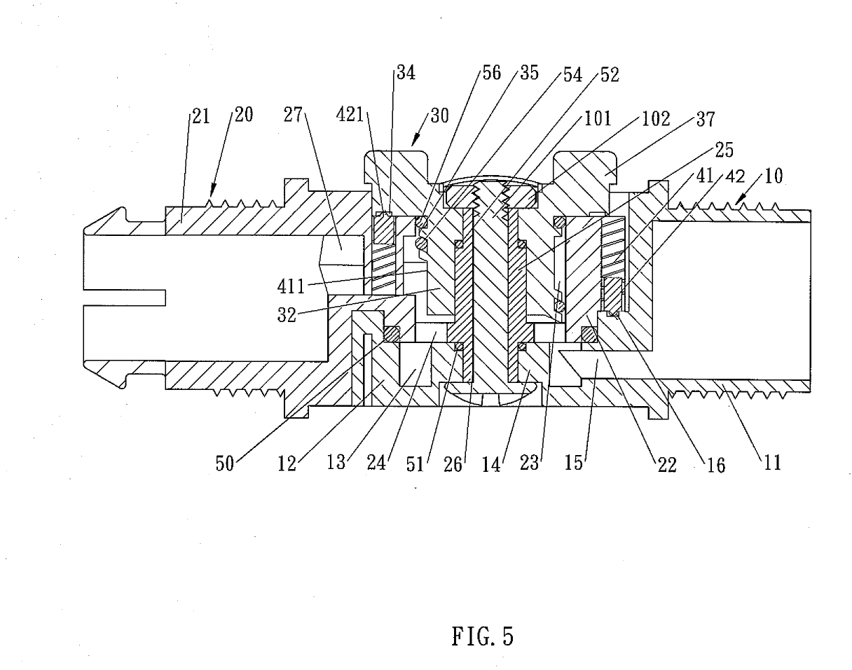

The control member 30 is mounted on the connecting member 20 and has a bottom 31 provided with a mounting tube 32 rotatably mounted in the flow chamber 23 of the connecting member 20. The mounting tube 32 of the control member 30 has a periphery provided with an oblique control flange 35 that is movable in the flow chamber 23 of the connecting member 20 to close or open the water inlet 27 of the connecting member 20. In such a manner, the mounting tube 32 of the control member 30 is rotatable in the flow chamber 23 of the connecting member 20 between a first position where the control flange 35 of the mounting tube 32 is movable to fully close the water inlet 27 of the connecting member 20 to interrupt a connection between the flow chamber 23 and the mounting section 21 of the connecting member 20 and a second position as shown in FIG. 5 where the control flange 35 of the mounting tube 32 is movable to open the water inlet 27 of the connecting member 20 to connect the flow chamber 23 to the mounting section 21 of the connecting member 20. The control member 30 has a top provided with a depression 33 and two opposite indication pieces 37 that are movable to align with the indication symbols of the connecting member 20 to indicate the ON/OFF state and the output flow of the adapter The mounting tube 32 of the control member 30 is rotatably mounted on the mounting post 25 of the connecting member 20. The bottom 31 of the control member 30 is located above the flow chamber 23 of the adapter body 10 to close the flow chamber 23 of the adapter body 10. The bottom 31 of the control member 30 has a periphery provided with a plurality of positioning bores 34. The control flange 35 of the control member 30 has an annular shape and has a periphery provided with a retaining groove 36 for mounting an O-ring 54 which is movable to close or open the water inlet 27 of the connecting member 20. The control flange 35 of the control member 30 extends along an outer wall of the mounting tube 32 in an oblique manner.

The pivot bolt 101 in turn extends through the mounting sleeve 14 of the adapter body 10, the mounting post 25 of the connecting member 20 and the mounting tube 32 of the control member 30, so that the mounting post 25 of the connecting member 20 is rotatably mounted on the mounting sleeve 14 of the adapter body 10, and the mounting tube 32 of the control member 30 is rotatably mounted on the mounting post 25 of the connecting member 20. The pivot bolt 101 abuts the connecting portion 12 of the adapter body 10, and a fastening nut 102 is screwed onto the pivot bolt 101 and abuts the control member 30, so that the connecting portion 12 of the adapter body 10, the connecting section 22 of the connecting member 20 and the control member 30 are combined together by the pivot bolt 101 and the fastening nut 102.

The adapter further comprises a positioning member 42 movably mounted in the receiving hole 28 of the connecting member 20 to move in concert with the connecting section 22 of the connecting member 20 and detachably positioned in one of the positioning holes 16 of the adapter body 10 to position the connecting section 22 of the connecting member 20 on the connecting portion 12 of the adapter body 10 temporarily, and an elastic member 41 mounted in the receiving hole 28 of the connecting member 20 and biased between the connecting member 20 and the positioning member 42 to push the positioning member 42 toward one of the positioning holes 16 of the adapter body 10.

The adapter further comprises a positioning element 421 movably mounted in the receiving bore 29 of the connecting member 20 and detachably positioned in one of the positioning bores 34 of the control member 30 when the control member 30 is rotatable relative to the connecting section 22 of the connecting member 20 to position the control member 30 on the connecting section 22 of the connecting member 20 temporarily, and an elastic element 411 mounted in the receiving bore 29 of the connecting member 20 and biased between the connecting member 20 and the positioning element 421 to push the positioning element 421 toward one of the positioning bores 34 of the control member 30.

The adapter further comprises an O-ring 50 mounted in the flow space 13 of the adapter body 10 and located between the connecting portion 12 of the adapter body 10 and the connecting section 22 of the connecting member 20 to provide a sealing effect between the connecting portion 12 of the adapter body 10 and the connecting section 22 of the connecting member 20, an O-ring 51 mounted on the mounting post 25 of the connecting member 20 and located between the mounting post 25 of the connecting member 20 and the mounting sleeve 14 of the adapter body 10 to provide a sealing effect between the mounting post 25 of the connecting member 20 and the mounting sleeve 14 of the adapter body 10, an O-ring 52 mounted on the mounting post 25 of the connecting member 20 and located between the mounting post 25 of the connecting member 20 and the mounting tube 32 of the control member 30 to provide a sealing effect between the mounting post 25 of the connecting member 20 and the mounting tube 32 of the control member 30, and an O-ring 56 mounted on the mounting tube 32 of the control member 30 and located between the mounting tube 32 of the control member 30 and the connecting section 22 of the connecting member 20 to provide a sealing effect between the mounting tube 32 of the control member 30 and the connecting section 22 of the connecting member 20.

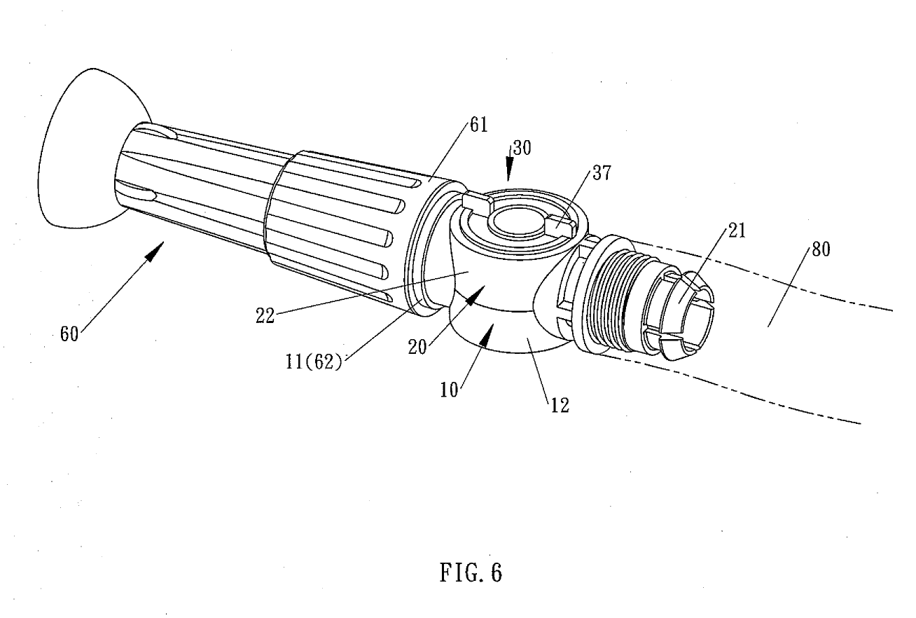

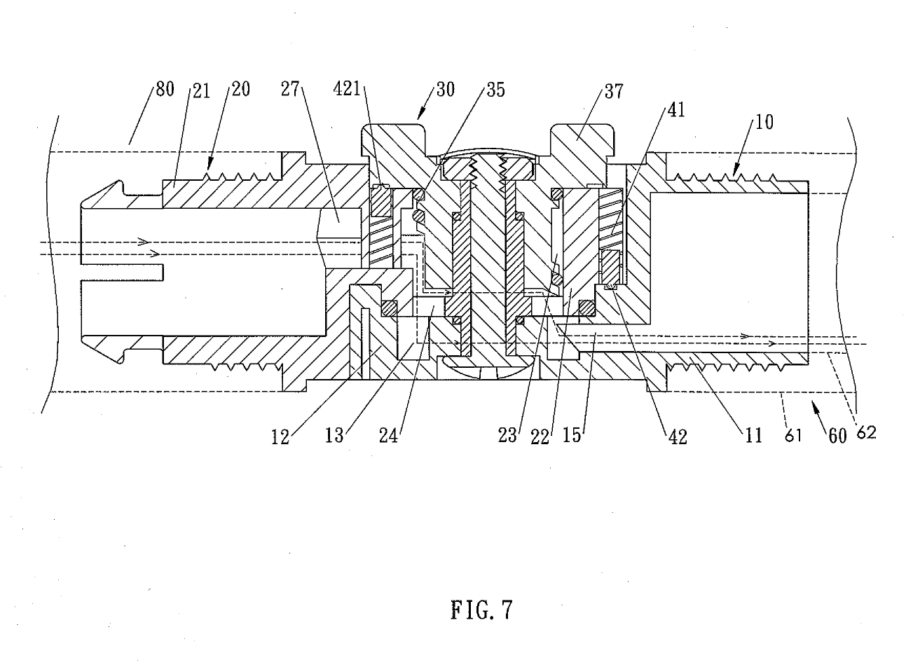

As shown in FIGS. 6 and 7, a spraying gun 60 has a shank 61 provided with an engaging hole 62 engaged with the mounting portion 11 of the adapter body 10, and a hose 80 is mounted on the mounting section 21 of the connecting member 20, so that the adapter is used to connect the spraying gun 60 and the hose 80.

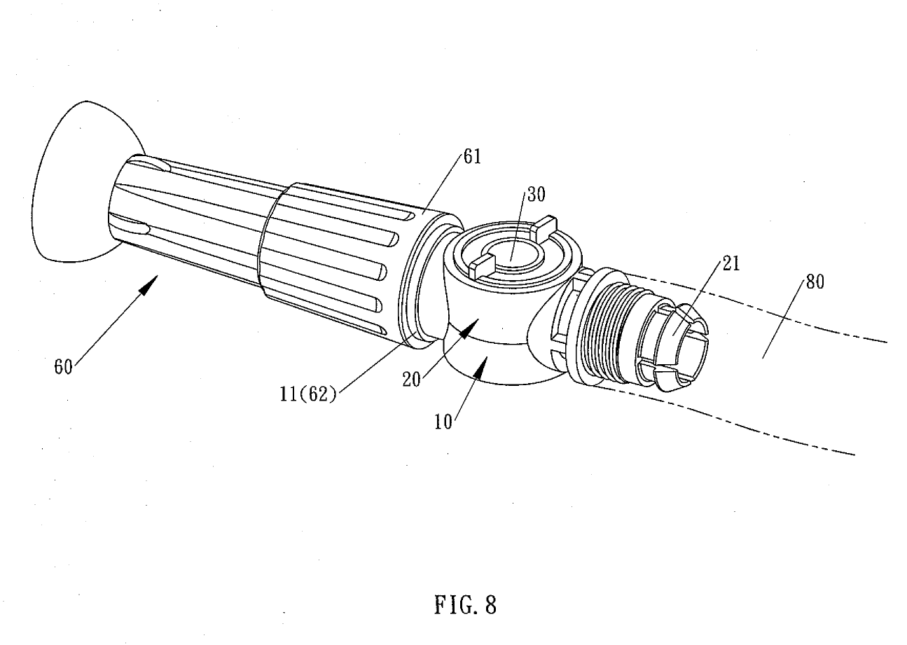

In operation, referring to FIGS. 1-8, when the control member 30 is rotated, the mounting tube 32 of the control member 30 is rotatable in the flow chamber 23 of the connecting member 20, so that the control flange 35 of the control member 30 is movable with the mounting tube 32 to close or open the water inlet 27 of the connecting member 20.

In such a manner, when the control flange 35 of the control member 30 is movable to close the water inlet 27 of the connecting member 20 and to interrupt the connection between the flow chamber 23 and the mounting section 21 of the connecting member 20, the flow passage between the flow chamber 23 and the mounting section 21 of the connecting member 20 is closed, so that the water from the hose 80 cannot flow through the mounting section 21 and the water inlet 27 of the connecting member 20 into the flow chamber 23 of the connecting member 20 so as to stop the water flow.

On the contrary, when the control flange 35 of the control member 30 is movable to open the water inlet 27 of the connecting member 20 and to connect the flow chamber 23 to the mounting section 21 of the connecting member 20, the flow passage between the flow chamber 23 and the mounting section 21 of the connecting member 20 is opened via the water inlet 27 of the connecting member 20, so that the water from the hose 80 can in turn flow through the mounting section 21 of the connecting member 20, the water inlet 27 of the connecting member 20, the flow chamber 23 of the connecting member 20, the connecting holes 24 of the connecting member 20, the flow space 13 of the adapter body 10, the water outlet 15 of the adapter body 10 and the mounting portion 11 of the adapter body 10 into the spraying gun 60 as shown in FIG. 7 for use with a user. At this time, the control flange 35 of the control member 30 extends along an outer wall of the mounting tube 32 in an oblique manner, so that the contact area between the control flange 35 of the control member 30 and the water inlet 27 of the connecting member 20 can be changed by rotation of the control member 30 so as to change and regulate the water output flow from the adapter.

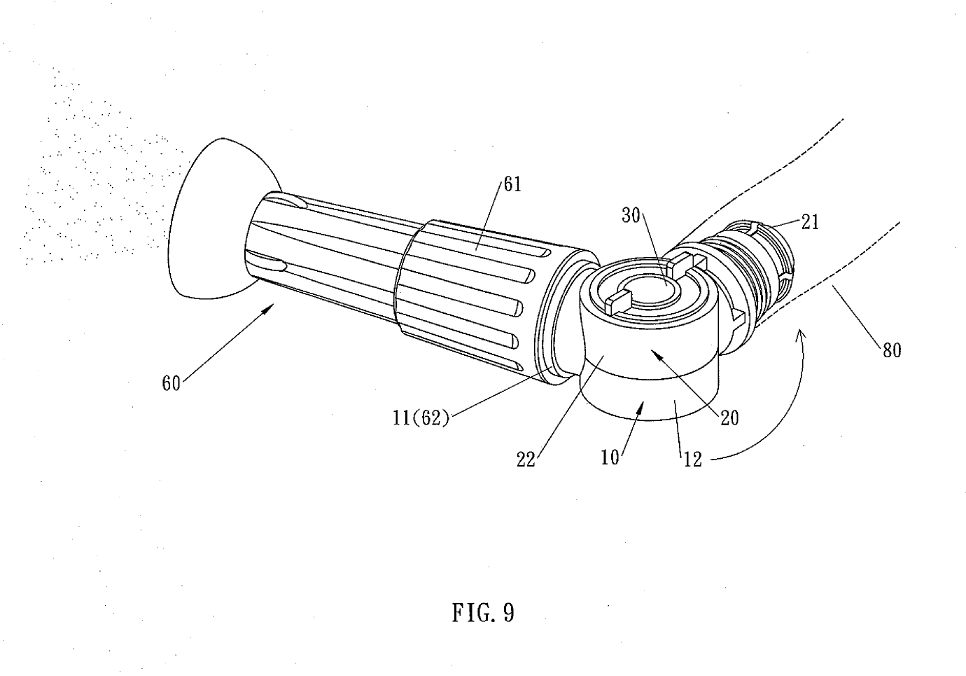

As shown in FIG. 9, the connecting section 22 of the connecting member 20 is rotatable relative to the connecting portion 12 of the adapter body 10 so that the connecting member 20 is pivotable relative to the adapter body 10 to adjust the angle between the connecting member 20 and the adapter body 10 so as to adjust the angle between the hose 80 and the spraying gun 60. In addition, the spraying gun 60 is a horizontal spraying gun.

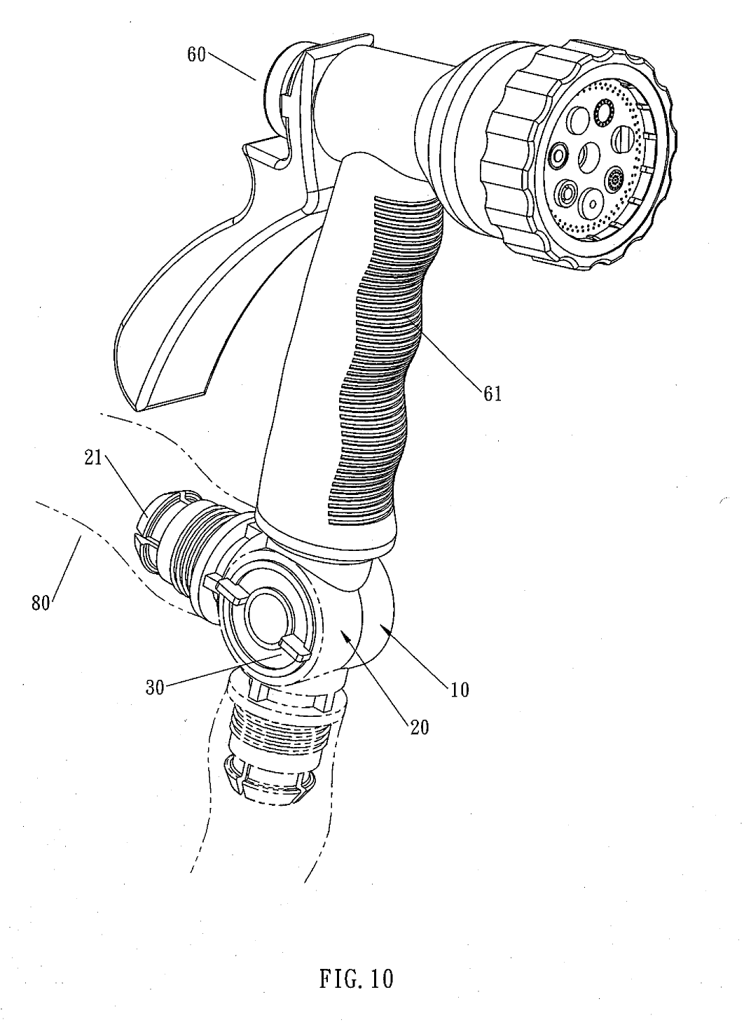

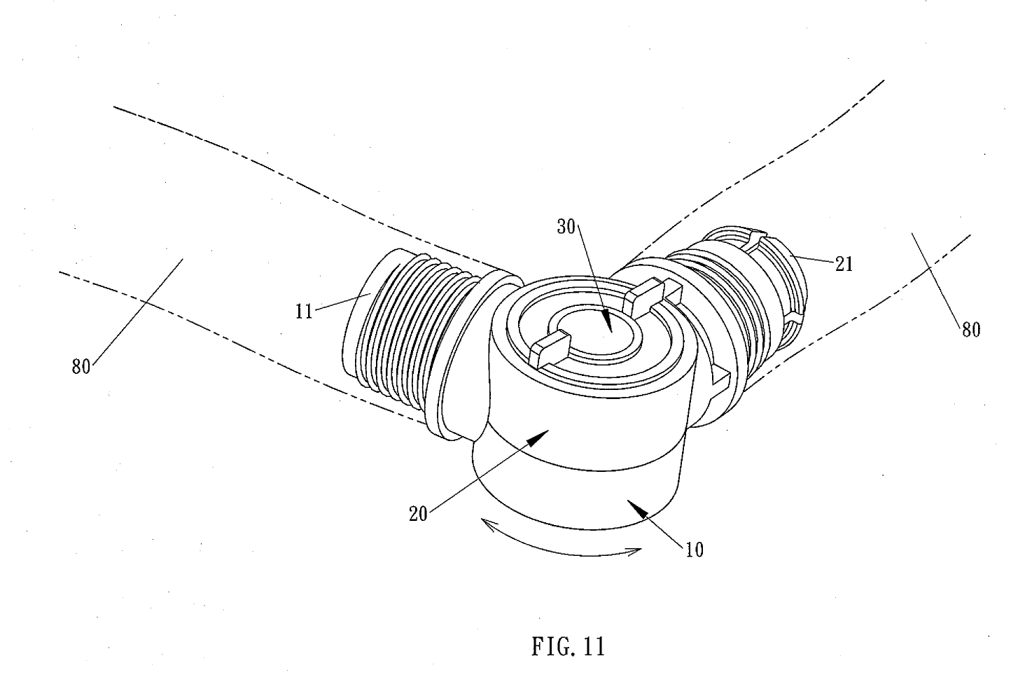

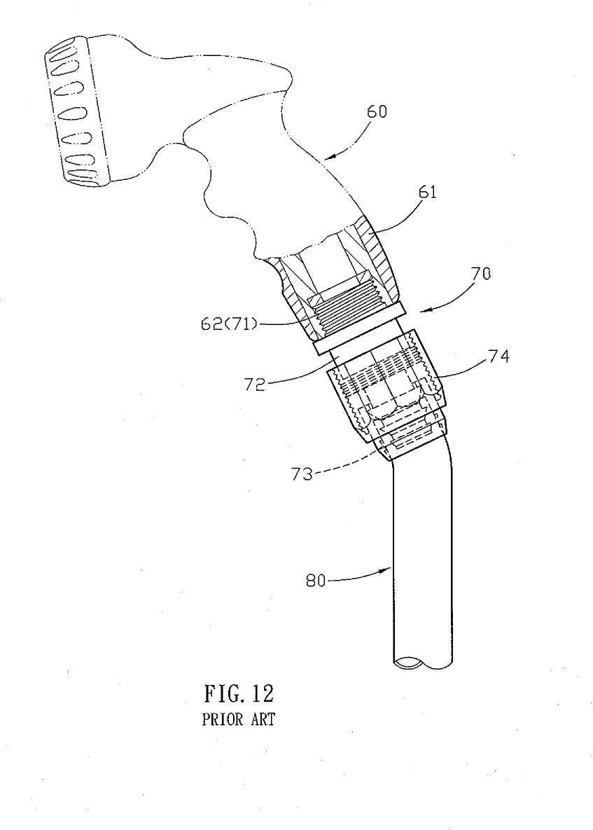

As shown in FIG. 10, the spraying gun 60 is an upright spraying gun so that the adapter is available for different types of spraying guns.

As shown in FIG. 1, the adapter is used to connect two hoses 80.

Accordingly, the control member 30 can be rotated to move the control flange 35, so that the control flange 35 of the control member 30 can be moved to close or open the water flow of the adapter and to change and regulate the water output flow from the adapter by rotation of the control member 30, thereby facilitating a user operating the adapter to close or open the water flow and to change and regulate the water output flow. In addition, the connecting member 20 is pivotable relative to the adapter body 10 to adjust the angle between the connecting member 20 and the adapter body 10 so as to adjust the angle between the hose 80 and the spraying gun 60 to prevent the hose 80 from being tangled with the spraying gun 60, thereby facilitating the user operating the spraying gun 60. Further, the connecting member 20 is pivotable relative to the adapter body 10 to adjust the angle between the hose 80 and the spraying gun 60, so that the hose 80 will not be rolled or revolved when the direction of the spraying gun 60 is changed, thereby preventing the hose 80 from being twisted, distorted or deformed. Further, the connecting portion 12 of the adapter body 10, the connecting section 22 of the connecting member 20 and the control member 30 are combined together by the pivot bolt 101 and the fastening nut 102, so that the adapter has a greater strength to withstand a water flow of high pressure.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An adapter, comprising an adapter body, a connecting member, and a control member; wherein:
the adapter body has a first side provided with a connecting portion and a second side provided with a hollow mounting portion;
the connecting portion of the adapter body has an inside provided with a recessed flow space;
the connecting portion of the adapter body has a peripheral wall provided with a water outlet connected between the flow space and the mounting portion;
the connecting member is mounted on the adapter body and has a first side provided with a connecting section mounted on the connecting portion of the adapter body and a second side provided with a hollow mounting section;
the connecting section of the connecting member has an inside provided with a recessed flow chamber and has a bottom provided with a plurality of connecting holes connected between the flow chamber and the flow space of the adapter body;
the connecting section of the connecting member has a peripheral wall provided with a water inlet connected between the flow chamber and the mounting section;
the control member is mounted on the connecting member and has a bottom provided with a mounting tube rotatably mounted in the flow chamber of the connecting member;
the mounting tube of the control member has a periphery provided with an oblique control flange that is movable in the flow chamber of the connecting member to close or open the water inlet of the connecting member.

2. The adapter in accordance with claim 1, wherein the inside of the connecting portion of the adapter body is provided with a mounting sleeve located in the flow space;
the inside of the connecting section of the connecting member is provided with a mounting post located in the flow chamber;
the mounting post of the connecting member has a lower end protruding outwardly from the bottom of the connecting section of the connecting member and inserted into the mounting sleeve of the adapter body so that the mounting post of the connecting member is rotatably mounted on the mounting sleeve of the adapter body;
the mounting tube of the control member is rotatably mounted on the mounting post of the connecting member.

3. The adapter in accordance with claim 2, wherein the connecting section of the connecting member is rotatably mounted on the connecting portion of the adapter body by a pivot bolt.

4. The adapter in accordance with claim 3, wherein
the pivot bolt in turn extends through the mounting sleeve of the adapter body, the mounting post of the connecting member and the mounting tube of the control member;
the mounting post of the connecting member is rotatably mounted on the mounting sleeve of the adapter body;
the mounting tube of the control member is rotatably mounted on the mounting post of the connecting member.

5. The adapter in accordance with claim 4, wherein the mounting post of the connecting member has an inside provided with a through hole to allow passage of the pivot bolt.

6. The adapter in accordance with claim 4, wherein
the pivot bolt abuts the connecting portion of the adapter body;
the adapter further comprises a fastening nut screwed onto the pivot bolt and abutting the control member;
the connecting portion of the adapter body, the connecting section of the connecting member and the control member are combined together by the pivot bolt and the fastening nut.

7. The adapter in accordance with claim 1, wherein
the connecting portion of the adapter body has a top provided with a plurality of positioning holes;
the bottom of the connecting section of the connecting member has a periphery provided with a receiving hole;
the adapter further comprises:
a positioning member movably mounted in the receiving hole of the connecting member to move in concert with the connecting section of the connecting member and detachably positioned in one of the positioning holes of the adapter body to position the connecting section of the connecting member on the connecting portion of the adapter body temporarily;
an elastic member mounted in the receiving hole of the connecting member and biased between the connecting member and the positioning member to push the positioning member toward one of the positioning holes of the adapter body.

8. The adapter in accordance with claim 1, wherein
the connecting section of the connecting member has a top provided with a receiving bore;
the bottom of the control member has a periphery provided with a plurality of positioning bores;
the adapter further comprises:
a positioning element movably mounted in the receiving bore of the connecting member and detachably positioned in one of the positioning bores of the control member when the control member is rotatable relative to the connecting section of the connecting member to position the control member on the connecting section of the connecting member temporarily;
an elastic element mounted in the receiving bore of the connecting member and biased between the connecting member and the positioning element to push the positioning element toward one of the positioning bores of the control member.

9. The adapter in accordance with claim 1, wherein the mounting tube of the control member is rotatable in the flow chamber of the connecting member between a first position where the control flange of the mounting tube is movable to fully close the water inlet of the connecting member to interrupt a connection between the flow chamber and the mounting section of the connecting member and a second position where the control flange of the mounting tube is movable to open the water inlet of the connecting member to connect the flow chamber to the mounting section of the connecting member.

10. The adapter in accordance with claim 1, wherein the control member has a top provided with a depression.

11. The adapter in accordance with claim 1, wherein the control member has a top provided with two opposite indication pieces.

12. The adapter in accordance with claim 2, wherein the mounting post of the connecting member has an upper end inserted into the mounting tube of the control member.

13. The adapter in accordance with claim 1, wherein the bottom of the control member is located above the flow chamber of the adapter body to close the flow chamber of the adapter body.

14. The adapter in accordance with claim 1, wherein the control flange of the control member has an annular shape.

15. The adapter in accordance with claim 1, wherein the control flange of the control member has a periphery provided with a retaining groove for mounting an O-ring which is movable to close or open the water inlet of the connecting member.

16. The adapter in accordance with claim 1, wherein the control flange of the control member extends along an outer wall of the mounting tube in an oblique manner.

17. The adapter in accordance with claim 3, wherein the connecting section of the connecting member is located between the connecting portion of the adapter body and the control member.

18. The adapter in accordance with claim 2, further comprising:
a first O-ring mounted in the flow space of the adapter body and located between the connecting portion of the adapter body and the connecting section of the connecting member to provide a sealing effect between the connecting portion of the adapter body and the connecting section of the connecting member;
a second O-ring mounted on the mounting post of the connecting member and located between the mounting post of the connecting member and the mounting sleeve of the adapter body to provide a sealing effect between the mounting post of the connecting member and the mounting sleeve of the adapter body;
a third O-ring mounted on the mounting post of the connecting member and located between the mounting post of the connecting member and the mounting tube of the control member to provide a sealing effect between the mounting post of the connecting member and the mounting tube of the control member;
a fourth O-ring mounted on the mounting tube of the control member and located between the mounting tube of the control member and the connecting section of the connecting member to provide a sealing effect between the mounting tube of the control member and the connecting section of the connecting member.
